(19) United States
(12) Patent Application Publication
(10) Pub. No.: US 2006/0045821 A1
(43) Pub. Date: Mar. 2, 2006

(54) Microreactor witii controllable pressure and temperature for in situ material investigations

(76) Inventors: Michael J. McKelvy, Chandler, AZ (US); Jason Diefenbacher, Phoenix, AZ (US); George H. Wolf, Mesa, AZ (US); Andrew V. Chizmeshya, Chandler, AZ (US)

Correspondence Address: TIFFANY & BOSCO;CAMELBACK ESPLANADE II, THIRD FLOOR, 2525 EAST CAMELBACK ROAD, PHOENIX, AZ, 85016, US

(21) Appl. No.: 10/523,233

(22) PCT Filed: Jul. 25, 2003
(86) PCT No.: PCT/US03/23426

§ 371 Date: Jan. 26, 2005

Related U.S. Application Data
(60) Provisional application No. 60/398,689, filed on Jul. 26, 2002.

(51) Int. Cl. B01J 19/00

(52) U.S. Cl. 422/130

(57) ABSTRACT

A microreactor (10) for investigation of material reactions and properties includes a core body (12) defining a chamber (22) adapted to contain one or more sample materials and having a fluid passageway (52) from the chamber to the exterior of the core body. The chamber is in fluid communication with an external manifold (50) whereby gases, liquids or fluids can be injected and their activities can be controlled externally from ambient conditions to 400 degrees Celsius and 4,500 psi. Transparent windows (30a, 30b) in the core body permit continuous visual access to the chamber, allow direct probe beam interaction with sample during a reaction or observation, and external detection of the probe beam to investigate in situ reaction processes.

### RELATED APPLICATION DATA

This application is based on and claims the benefit of U.S. Provisional Patent Application No. 60/398,689 filed on Jul. 26, 2002, which is incorporated herein by this reference.

### STATEMENT OF GOVERNMENT FUNDING

The United States Government provided financial assistance for this project through the Department of Energy under Grant No. IF-01262. Therefore, the United States Government may own certain rights to this invention.

### BACKGROUND

The present invention relates to reaction cells for observation of in situ reactions and/or material properties. More specifically, it relates to a miniature reaction cell for the study of in situ solid-fluid and fluid-fluid reaction, as well individual solid-fluid and fluid-fluid reactions/interactions in multi component systems, wherein the pressure and temperature can be fully controlled during reaction.

A wide range of high-pressure and temperature studies of materials have been successfully carried out using diamond-anvil-cells (DACs) and hydrothermal DACs. One such study of ultrahigh pressure transitions in solid hydrogen using a DAC is described by Mao, H. K. and Hemley, R. J., 66 Rev. Mod. Phys. 671 (1994), which is incorporated herein by this reference. Such studies, however, are often limited to very small reaction volumes due to the scarcity and high cost of suitable diamonds. See, for example, Mao and Hemley, supra, and Xu, Ji-an Mao, Ho-kwang 290 Science 783 (2000), which is incorporated herein by this reference. This limits the control of critical reaction process parameters, including reactant activity, over pressure and temperature ranges of interest, such as for pressures ranging from 0 to 4,500 psi and temperatures from 20 to 400° C. Larger batch style diamond cells of about 6 μl have been developed to study solid-fluid reactions, as described by Fulton, J. L., Darab, J. G. and Hoffman, M. M., 72 Rev. Sci. Instrum. 2117 (2001), which discusses X-ray absorption spectroscopy and imaging of heterogeneous hydrothermal mixtures using a diamond microreactor cell. Such cells, however, do not offer external reactant activity control. External activity control is available in diamond flow cells designed to probe fluid phases (e.g., aqueous solution) under controlled temperatures and pressures, as disclosed by Hoffman, M. M., Addleman, R. S. and Fulton, J. L. 71 Rev. Sci. Instrum. 1552 (2000). These cells, however, are not well suited for the study of solid-fluid or multicomponent solid-fluid and fluid-fluid properties and reactions.

Although internal pressure control has previously been used in previous designs, it has been found to be difficult to incorporate, and inaccurate at best, for the pressure and temperature range of interest herein (ambient temperature and pressure to 400° C. and 4,500 PSI). In prior designs, reactant pressure/activity inherently decreases as a reaction progresses and the reactant gas/fluid is consumed. This effect is particularly limiting, as reaction conditions cannot be well controlled during observation.

There is a need, therefore, for an apparatus that provides better control of pressure and temperature during in situ material investigations, including solid-fluid and fluid-fluid reaction investigations as well individual solid-fluid and fluid-fluid reactions and interactions in multi-component systems. It is an object of the present invention to provide such an apparatus.

Additional objects and advantages of the invention will be set forth in the description that follows, and in part will be apparent from the description, or may be learned by practice of the invention. The objects and advantages of the invention may be realized and obtained by the instrumentalities and combinations pointed out herein.

### SUMMARY

To achieve the foregoing objects, and in accordance with the purposes of the invention as embodied and broadly described in this document, there is provided a microreactor for investigation of material reactions and properties. The microreactor includes a novel chamber design for in situ investigations of commercially and fundamentally important reaction processes with full external temperature and pressure control from ambient conditions to 400° C. and 4,500 psi. The sample chamber is in fluid communication with an external manifold, whereby gases, liquids or fluids can be injected and their activities can be controlled externally. Because pressurizing fluid (which can be supercritical or subcritical fluid, gas or liquid) can be externally supplied, the microreactor allows the activity of the pressure medium, as well as the pressure itself, to be fully controlled as the medium is consumed during reaction or observation. Such external pressure and activity control has not been available for solid-fluid or combined solid-fluid and fluid-fluid investigations in the past. The system thus enables the investigation of a variety of materials under controlled temperature, pressure, and activity conditions.

The microreactor includes transparent windows that allow direct probe beam (light, X-rays, etc.) interaction with a sample during a reaction or observation, as well as external detection of the probe beam to investigate in situ reaction processes. The windows permit sequential or simultaneous microscopic observation of the sample (e.g., before, during and after reaction) and continuous visual access to the chamber.

The invention has the inherent advantages of (i) precise control of the pressure and activity of the gas or fluid of interest (ii) allowing investigations to be observed under constant reactant gas or fluid activity (e.g., pressure); and (iii) allowing the study of equations of state of systems in the absence of reactions (e.g., phase transitions in fluids).

Potential commercial applications of the novel microreactor of the invention are broad in scope. The microreactor can be used for the in situ investigation of a variety of important chemical and materials processing applications involving supercritical or near supercritical, as well as subcritical fluids. These include organic and organometallic reactions, pharmaceutical materials processing, organic waste decomposition, geochemical and mineralogical reactions, and solvothermal materials synthesis reactions. For example, ammonolysis and hydrogenation reactions in supercritical fluids provide a useful alternative to standard synthesis methods. In addition, organic synthetic reactions using supercritical (CO₂) fluids can eliminate the organic waste solvents that are used in traditional methods. Similar applications extend to commercially important solvent extraction processes, such as the decaffeination of coffee. There are important advantages in the preparation of drug delivery systems using supercritical fluids rather than standard organic solvents (e.g., polymer encapsulation of drugs and production of monodispersed micron-sized proteins and other compounds). Decomposition oxidation reactions of fluorocarbons and other organic waste materials are efficiently achieved using supercritical aqueous solvents. Moreover, there is a growing use of solvothermal methods in the production and processing of inorganic materials to which the microreactor can be applied.

### BRIEF DESCRIPTION OF THE DRAWINGS

The accompanying drawings, which are incorporated in and constitute a part of the specification, illustrate the presently preferred embodiments and methods of the invention. Together with the general description given above and the detailed description of the preferred embodiments and methods given below, they serve to explain the principles of the invention.

FIG. 1 is an exploded view of an exemplary embodiment of a microreactor according to the present invention.

FIG. 2 is a cross-sectional view of the assembled microreactor of FIG. 1 also showing in schematic form the connection of the core chamber to an external source of a gas or fluid of interest for providing external pressure and activity control.

FIG. 3 is a perspective view of the core of the microreactor of FIG. 1 showing the core construction in more detail

FIG. 4 is a cross-sectional plan view of the microreactor core of FIG. 3 showing the fluid passageway and the thermocouple well.

FIG. 5 is a cross-sectional plan view of the microreactor core of FIG. 3.

FIG. 6 shows one embodiment of a heater assembly for heating the microreactor chamber according to the invention.

FIG. 7 is an example of an optional sample holder for use with the microreactor to hold a solid sample for observation.

FIG. 8 is a cross-sectional view of the assembled microreactor of FIG. 1 showing an exemplary sample holder in the chamber and showing the chamber containing gas and liquid-rich reaction media.

### DESCRIPTION

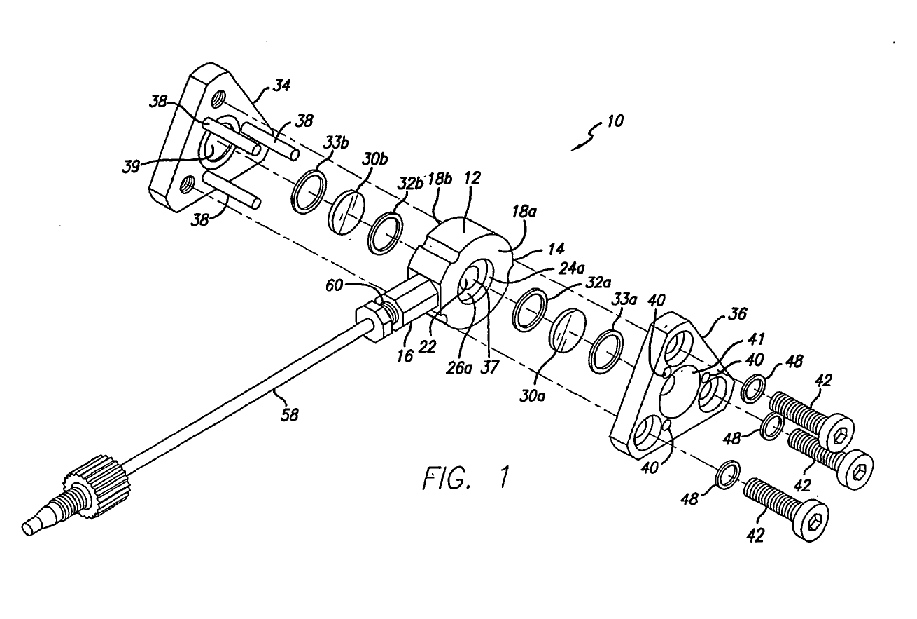

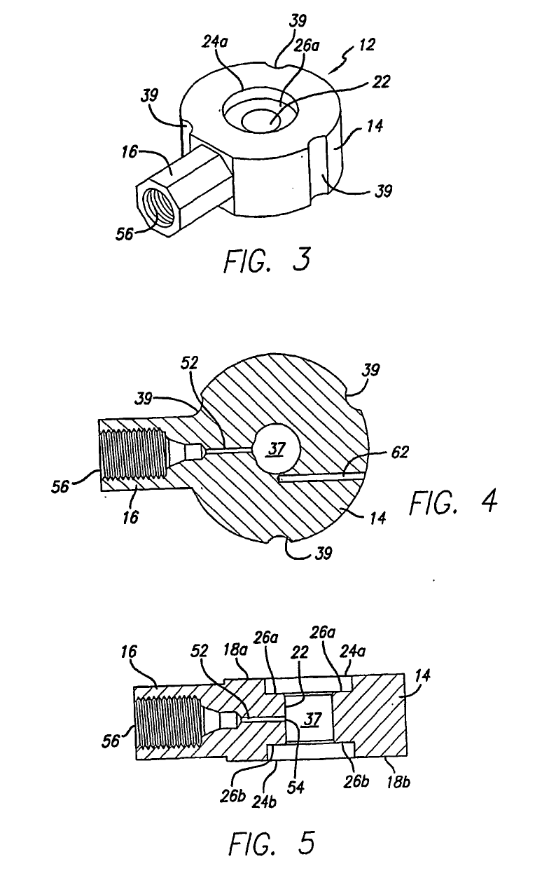

Referring to FIGS. 1 through 5, an exemplary embodiment of a microreactor according to the present invention is shown. The microreactor 10 includes a core 12 having a generally cylindrical body 14 and a neck 16. The microreactor core 12 is made of a corrosion resistant material, such as metal. The core body 14 has two generally flat opposing faces 18a, 18b. A bore 22 extends through the core body 14 to form openings 24a, 24b in the core faces 18a, 18b. Each of the openings 24a, 24b is countersunk to form a shoulder 26a, 26b within the bore 22 near each opening 24a, 24b. The core body 14 is made to accommodate optically and probe transparent windows 30a, 30b at both ends of the bore 22. The window materials allow for visual and spectroscopic access to the chamber 37 for the various analysis techniques to be employed. Suitable materials for the windows 30a, 30b may include, for example, moissanite or sapphire. Each of the windows 30a, 30b is positioned within each of the openings 24a, 24b and is seated against a flat sealing gasket 32a, 32b, which rests against the shoulder 26a, 26b of the opening 24a, 24b. The sealing gaskets 32 should be corrosion resistant and must be sufficiently deformable to provide a tight seal. Suitable materials for the sealing gaskets 32 may include elastomers, metals (e.g., Kalrez or gold) or graphite material (e.g., graflex). Other sealing materials (e.g., o-rings) may also be used. The core 12, sealing gaskets 32a, 32b and windows 30a, 30b are held together within a clamping frame comprising a frame backing plate 34 and an opposing frame pressure plate 36. The backing plate 34 and pressure plate 36 are made from a material having sufficient rigidity and durability to hold the assembly of the core 12, sealing gaskets 32a, 32b and windows 30a, 30b in place over the temperature and pressure ranges of interest. If necessary, the thermal stability of the sealing gaskets 32a, 32b at higher temperatures may be improved by matching the thermal expansivity of the frame plates 34, 36 and the associated frame assembly to that of the microreactor assembly. It is also preferable to use flexible gaskets as stress relief gaskets 33a, 33b between the clamping frame and the windows 30a, 30b to minimize the stress on the windows 30a, 30b.

When assembled in this configuration, the bore 22 and windows 30a, 30b form a chamber 37 that provides a relatively large volume (e.g., 0.1 ml) pressure vessel for controlled materials and reaction observation. Advantageously, the vessel volume can be increased to accommodate larger volume investigations simply by using a core of larger size. The windows 30a, 30b allow observation of the chamber, as described in more detail below. The windows 30a, 30b are of a material that allows for the transmission of a probe beam through the windows 30a, 30b used for investigation of materials and reactions in the chamber 37. Observation openings 39, 41 extend through the plates 34, 36 to expose the windows 30a, 30b. The observations openings 39, 41 are tapered at an angle to allow for detection of a diffracted probe beam transmitted through the windows 30a, 30b, such as X-ray diffraction. The investigative methods which can be utilized with the microreactor include, but are not limited to, X-ray, Raman, infrared, and neutron spectroscopy and/or diffraction. Nuclear magnetic resonance (NMR) studies are also possible when the core 12 is constructed with a non-ferrous material, such as Be-doped copper, and electrical feed-throughs are added. The windows 30a, 30b also preferably are transparent to permit visual inspection of the chamber 37 and the materials in the chamber.

The backing plate 34 includes a plurality of guide rods 38 extending perpendicularly from the backing plate 34. The guide rods 38 are positioned and sized to be received in and extend through corresponding alignment holes 40 in the pressure plate 36 when the microreactor 10 is assembled. When assembled, the guide rods 38 rest in alignment notches 39 located in the periphery of the core body 14, thereby providing for precise alignment of the core 12 between the plates 34, 36. The pressure plate 36 is removably secured to the backing plate 34 using cap screws 42 that extend through holes 44 in the pressure plate 36 and are screwed into threaded screw holes 46 in the backing plate 34. When the cap screws 42 are tightened, the backing plate 34 and pressure plate 36 press the windows 30a, 30b tightly against the sealing gaskets 32a, 32b to form a seal that prevents gases or fluids in the chamber 22 from leaking out and prevents ambient air from entering the chamber 22. Further thermal stability of the assembly an be achieved by the use of spring-type washers 48 with the cap screws 42.

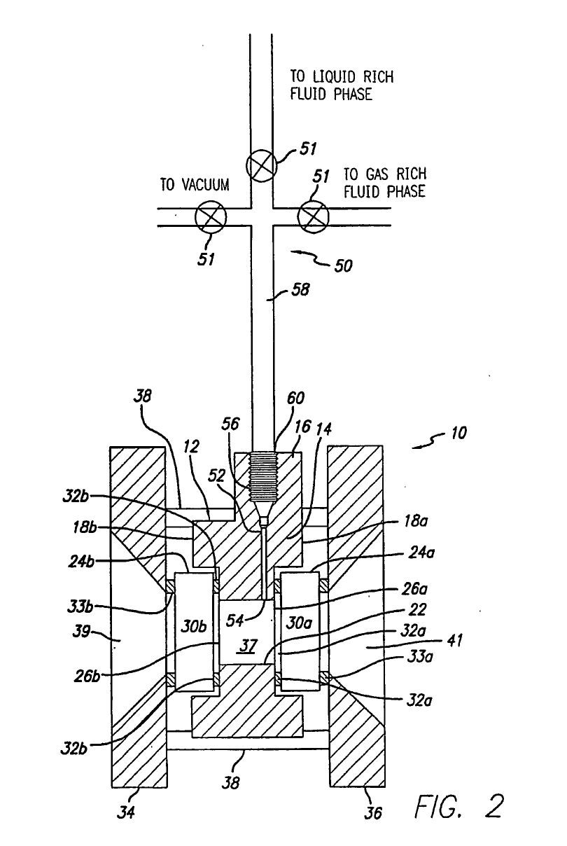

Within the core neck 16 is a fluid passageway 52 that terminates at one end in an input port 54 in the wall of bore 22 and terminates at the other end in a threaded opening 56 for receiving an external high-pressure fluid supply line 58, as shown in FIG. 2. The fluid supply line 58 has a high-pressure threaded fitting 60 on one end that is inserted into the threaded opening 56. The fitting 60 preferably is a small fitting that has minimal impact on the overall volume of the core chamber 37 and that can tolerate the pressures and temperatures to which the microreactor will be subjected (e.g., a high-pressure liquid chromatography fitting). The other end of the fluid supply line 58 is coupled to a manifold 50. The manifold 50 includes one or more valves 51, which can be used to couple one or more sources of gases, liquids or fluids to the supply line 58 and chamber 37. In this configuration one or more gases, liquids or fluids can be injected into the chamber 37 and their activities controlled externally during the reaction or observation of interest. Preferably, the manifold 50 includes a connection to a vacuum line, which can be used to evacuate the chamber 37 and supply line 58 to remove unwanted gases and fluids. For example, the vacuum line can be used to remove air from the chamber 37 and supply line 58 before injecting a fluid into the chamber 37 to load it for observation. The external connectivity of the chamber 37 to the supply line 58, manifold 50 and external gas/fluid sources allows for accurate control and measurement of the pressure and activity of external gas or fluid to be input into microreactor chamber 37. The configuration of the manifold connections shown in FIG. 2 is but one example of connectivity for loading fluid(s). It will be understood by those skilled in the art that other connection configurations are readily achievable. After the microreactor is loaded, any of the external connections shown can be used to connect the gas/fluid of interest to the reaction chamber and provide external pressure and activity control.

Referring to FIG. 4, a thermocouple well 62 extends from the exterior of the core body 14 to a point within the core body very near the reaction chamber 37 (e.g., within a millimeter of it) but without penetrating into the chamber 37. The thermocouple well 14 is sized to receive a thermocouple (not shown) for measuring the temperature of the core body 14 adjacent the chamber. In this configuration, no seals are needed for the thermocouple, yet it provides an accurate reading of the internal sample and microreactor temperature.

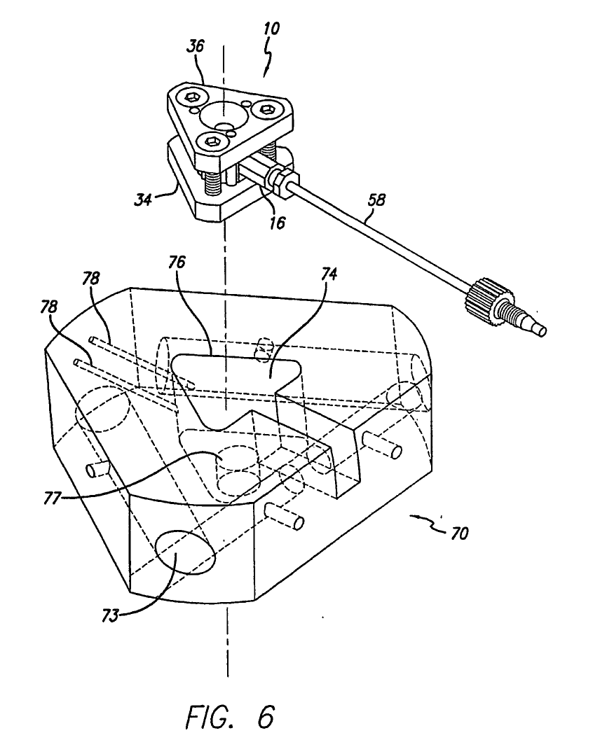

The microreactor chamber 37 can be heated or cooled by any means known in the art. In one advantageous embodiment, the microreactor chamber 37 is heated using a heater like that shown in FIG. 6. The heater 70 comprises a heat-conducting body 72 with a well 74 for closely holding the assembled microreactor 10 so that the frame of the assembled microreactor is in thermal contact with the heater body 72. In a presently preferred embodiment, the heater body 72 is made of brass. Heating elements known in the art (not shown) are disposed within heating element cavities 73 the body 72. The heater 70 includes an opening 76 for inserting the microreactor 10 into the heater well 74. The heater opening 76 and an opposing opening 77 expose the observation openings 39, 41 and windows 30a, 30b of the microreactor assembly 10 to allow for transmission of a probe beam through the chamber 37. The heater body 72 also includes thermocouple passageways 78 located to align with the thermocouple well 62 of the microreactor assembly 10 to allow for insertion of a thermocouple into the microreactor core 12 when the microreactor assembly 10 is resting in the heater well 74. The thermocouple passageways 78 are symetrically located so that this insertion can be achieved regardliss of which orientation the microreactor assembly 10 is placed into the heater well 74.

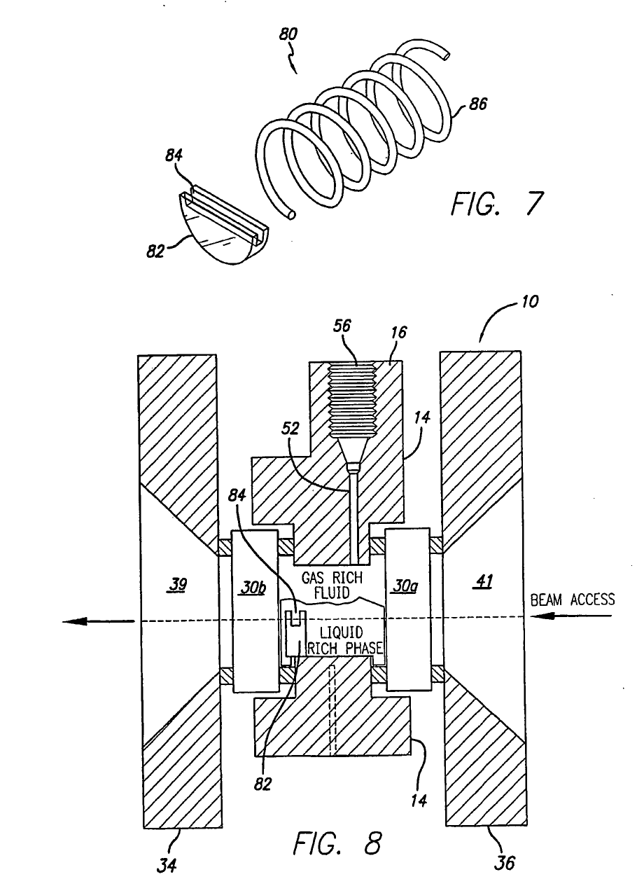

By disassembling the backing plate 34 and the pressure plate 36 and removing the windows 30a and 30b, a solid sample can be loaded into or removed from the microreactor chamber 37. Referring to FIGS. 7 and 8, an example is shown of a sample holder 80 that can be used to hold a solid sample in a fixed position within the chamber 37 for observation for horizontal microreactor applications, i.e. applications where the probe beam is and windows 30a, 30b are aligned generally horizontally. The sample holder 80 comprises an optically and probe transparent half-disk 82 having a slit 84 formed therein for holding the solid sample. A corrosion resistant retainer spring 86 holds the half-disk 82 firmly in place against the exit window 30b. For vertical applications, the sample can, for example, simply rest on the interior surface of the bottom window 30b. In the example of FIG. 8, the sample holder 80 is shown to the left side of the interior of the chamber 37, with the probe beam entering from the right and exiting and being detected to the left. It will be understood, however, that beam access can be from either side, with the sample holder 80 positioned accordingly and it will be apparent to those of skill in the art that the microreactor of the present invention can be used with many different sample positioning options. In the exemplary reaction setup of FIG. 8, a two-phase mixture consisting of a liquid-rich phase and a gas-rich fluid are shown, with the liquid-rich phase in contact with a solid sample that can be loaded in the sample holder 80. This allows in situ observations of the reaction of the solid with the liquid-rich phase, as well as simultaneous observations of the interactions between the liquid-rich phase and the gas-rich fluid. Supercritical, as well as gas- and liquid-rich fluids can be investigated in combination with fluid-solid reactions.

An embodiment of a microreactor according to our invention has been manufactured and successfully used up to 400° C. and 4,500 psi, with independent temperature and pressure control. The microreactor core 12 is made of Hastelloy C-276 and has a chamber volume of about 0.1 ml. The windows 30a, 30b are made of moissanite. The sealing gaskets 32a, 32b are made of graflex. The frame plates 34, 36 are made of stainless steel. The microreactor has been found to be leak tight for periods of up to a month. The microreactor has been successfully used for X-ray synchrotron work and Raman spectroscopy, and it can be easily adapted to utilize FTIR spectroscopy, neutron scattering, NMR spectroscopy as well as other techniques for in situ investigations of materials and reaction processes under controlled pressure and temperature.

The microreactor according to our invention can be used to study any combination of compatible solids and fluids (supercritical fluids, gases and liquids), and can be used to study materials in vacuum and in elevated pressures and in sub-ambient temperatures as well as in elevated temperatures.

The above-described invention possesses numerous advantages as described herein. The invention in its broader aspects is not limited to the specific details, representative devices, and illustrative examples shown and described. Accordingly, departures may be made from such details without departing from the spirit or scope of the general inventive concept.

1. A microreactor for investigation of material reactions and properties, the microreactor comprising:
a core body defining a chamber adapted to contain one or more sample materials and having a fluid passageway from the chamber to the exterior of the core body; and
one or more controllable fluid supplies that are adapted to supply one or more fluids to the chamber under controlled conditions at a pressure up to about 4,500 psi;
wherein the body has a window for investigating reactions in the chamber.

2. (canceled)

3. The microreactor according to claim 1 further comprising a heater adapted to heat the chamber.

4. The microreactor according to claim 3 wherein the heater is adapted to heat the chamber to a temperature in a range from about 20° C. to about 400° C.

5. The microreactor according to claim 1 wherein at least one of the one or more fluid supplies is coupled to the fluid passageway using a high-pressure fitting.

6. The microreactor according to claim 1 wherein the chamber is visible through the window in the body.

7. The microreactor according to claim 1 wherein the window is adapted to allow transmission of a probe beam into the chamber and to allow observation of the chamber.

8. The microreactor according to claim 7 further comprising a second window adapted to allow transmission of the probe beam out of the chamber and enhance observation of the chamber.

9. The microreactor according to claim 7 wherein at least one of the windows comprises moissanite.

10. The microreactor according to claim 7 wherein at least one of the windows comprises sapphire.

11. The microreactor according to claim 1 wherein the chamber has a volume of about 0.1 ml or more.

12. The microreactor according to claim 1 wherein the core body includes a well disposed within the core body without penetrating the chamber and having an opening to the exterior of the core body, whereby a temperature sensor can be inserted into the core body near the chamber to allow an accurate reading of temperature of the microreactor.

13. The microreactor according to claim 1 further comprising a temperature sensor adapted to measure temperature of the chamber.

14. The microreactor according to claim 13 wherein the temperature sensor comprises a thermocouple positioned in the core body near the chamber.

15. The microreactor according to claim 1 wherein the core body comprises a corrosion resistant material.

16. The microreactor according to claim 1 wherein the core body comprises metal.

17. The microreactor according to claim 1 wherein the core body comprises Hastelloy C-276.

18. The microreactor according to claim 1 wherein the core body comprises a non-ferrous material.

19. The microreactor according to claim 1 wherein the core body comprises Be-doped copper.

20. The microreactor according to claim 1 wherein the core body includes an access opening for placing a sample in the chamber and removing the sample from the chamber.

21. The microreactor according to claim 1 further comprising a sample holder disposed within the chamber and adapted to hold one or more solid samples.

22. The microreactor according to claim 21 wherein the sample holder comprises a corrosion-resistant material.

23. The microreactor according to claim 21 wherein the sample holder comprises a material that allows transmission of a probe beam through the sample holder and allows visual observation of the sample.

24. The microreactor according to claim 21 wherein the sample holder comprises moissanite or sapphire.

25. A method of investigating the reaction or properties of materials in situ, the method comprising:
providing a microreactor comprising:
a core body defining a chamber adapted to hold one or more sample materials; and
a fluid passageway in communication with the chamber and adapted to be coupled with one or more fluid supplies;
placing the one or more sample materials into the chamber;
sealing the chamber;
evacuating the chamber to remove unwanted gases and fluids;
coupling a supply of a fluid to the fluid passageway;
supplying one or more fluids to the chamber under controlled conditions; and
observing a reaction or properties of the one or more sample materials and the one or more fluids;
wherein the step of supplying a fluid to the chamber under controlled conditions comprises supplying fluid to the chamber at a pressure up to about 4,500 psi.

26. (canceled)

27. The method according to claim 25 further comprising heating the chamber.

28. The method according to claim 27 wherein the step of heating the chamber comprises heating the chamber to a temperature in a range from about 20° C. to about 400° C.

29. The method according to claim 25 wherein the step of observing the reaction or properties comprises viewing or probing the chamber through a window in the body.

30. The method according to claim 25 wherein the step of observing the reaction or properties comprises transmitting a probe beam into the chamber through a first window adapted to allow transmission of the probe beam through the window.

31. The method according to claim 30 wherein the step of observing the reaction or properties further comprises detecting the probe beam through the first or a second window.

32. The method according to claim 31 wherein the probe beam comprises an X-ray beam.

33. The method according to claim 31 wherein the probe beam comprises infrared light.

34. The method according to claim 31 wherein the step of observing the reaction or properties utilizes Raman spectroscopy with laser illumination.

35. The method according to claim 31 wherein the step of observing the reaction or properties utilizes neutron spectroscopy with a beam of collimated thermal neutrons.

36. The method according to claim 25 wherein the step of observing the reaction or properties utilizes NMR spectroscopy.

37. The method according to claim 25 wherein the step of supplying a fluid to the chamber under controlled conditions comprises supplying the fluid to the chamber under a controlled temperature.

38. The method according to claim 25 wherein the step of supplying a fluid to the chamber under controlled conditions comprises supplying the fluid to the chamber under a controlled pressure.

39. The method according to claim 25 wherein the step of supplying fluid to the chamber under controlled conditions comprises supplying fluid to the chamber in a controlled amount.

40. The method according to claim 25 wherein the step of supplying fluid to the chamber under controlled conditions comprises supplying fluid to the chamber with a controlled activity.

41. The method according to claim 25 wherein the step of supplying a fluid comprises supplying a fluid in a supercritical fluid state.

42. The method according to claim 25 wherein the step of supplying a fluid comprises supplying a fluid in a liquid-rich phase.

43. The method according to claim 25 wherein the step of supplying a fluid comprises supplying a fluid in a gas-rich phase.

44. A microreactor for investigation of material reactions and properties, the microreactor comprising:
a core body defining a chamber adapted to contain one or more sample materials and having a window for investigating reactions in the chamber; and
one or more controllable fluid supplies that are adapted to supply one or more fluids to the chamber under controlled conditions at a pressure above about 5 psi and below about 4,500 psi.

45. The microreactor according to claim 44 further comprising a heater adapted to heat the chamber.
